(19) United States
(12) Patent Application Publication
(10) Pub. No.: US 2009/0229689 A1
(43) Pub. Date: Sep. 17, 2009

(54) WATER DIVERSION DEVICE

(76) Inventor: Graham Roy Booth, Carindale (AU)

Correspondence Address: HOWARD & HOWARD ATTORNEYS PLLC, 450 West Fourth Street, Royal Oak, MI, 48067, US

(21) Appl. No.: 12/049,404

(22) Filed: Mar. 17, 2008

(51) Int. Cl. F16K 11/00

(52) U.S. Cl. 137/597

(57) ABSTRACT

A rain water diversion device for insertion in a truncated down pipe comprises an upper deflecting section (2) and a mating lower diverting section (1) which is divided into two communicating compartments one of which, in use, feeds an outlet (6) and the other of which receives overflow from the first compartment.

### FIELD OF THE INVENTION

This invention relates to devices for diverting water from down pipes of roofs into storage tanks or swimming pools, or for watering gardens so that water is not lost to storm water drains.

### BACKGROUND OF THE INVENTION

Australian patent application 2003212067 discloses a device that can be inserted in a down pipe from a roof to divert rain water away from the storm water drains which usually receive the pipes. This device collects water flowing down the pipe in a chamber formed between outer and inner conduits and taps it off through an outlet in the outer conduit. When the flow down the pipe exceeds the maximum outflow through the outlet, the chamber fills and overflows into the inner conduit which connects to the lower down pipe.

Although this device achieves the diversion of rain water some find it has a number of disadvantages. For example, it can be difficult to insert the device into a down pipe while preserving the integrity of the pipe. Also manufacture of the device is relatively expensive because of the amount of material in the inner and outer conduits and the tooling required to form the chamber between the inner and outer conduits. And the coupling joint of 2006100253 further increases the cost of installation without changing the efficiency of the device.

There are also other prior art devices which attempt to divert water from roof down pipes, but that also have technical disadvantages. For example, Australian innovation patent no. 2006100253 describes a coupling joint that further increases the cost of installation without changing the efficiency of the device. Australian innovation patent no. 2004100197 discloses a diverter formed from a one piece section of down pipe with a deflector plate which directs water into a collector chamber which has a single hose outlet. This deflector is both difficult to form and to insert in the downpipe and has a limited outlet capacity.

### SUMMARY OF THE INVENTION

According to the present invention a rain water diversion device for insertion in a truncated down pipe comprises an upper deflecting section, and a mating lower diverting section with an outlet which is divided into two communicating compartments, one of which feeds the outlet and the other of which receives the overflow from the first compartment.

In one embodiment, the device is fabricated so that the deflecting section mates with the upper truncated down pipe and the diverting section fits into the lower truncated down pipe.

In one embodiment, the deflecting section has a plate closing off slightly more than half its cross section to deflect water to one side of the diverting section which is longitudinally divided into two by a divider and has a plate below the water fed side of the mid section which diverts the water through an outlet, while backed up water flows over the divider into the other side of the mid section which feeds into the lower down pipe.

In one embodiment, the device has a circular cross section to mate with a standard circular down pipe.

In one embodiment, the deflector and diverter plates are angled downwards and the outlet is located just above the diverter plate to streamline the flow and to prevent pooling of the water.

In one embodiment, the outlet contains a valve which adjusts the rate of outflow.

In one embodiment, the diversion section has a second outlet.

In one embodiment, the deflection section can be rotated through 180 degrees to an OFF position so that no water is diverted to the outlets.

It is therefore an object of the present invention to provide a rain water diversion device which is simpler and cheaper to manufacture and install than the prior art devices or at least provides a useful alternative.

### BRIEF DESCRIPTION OF THE DRAWINGS

An embodiment of the invention is now described byway of example only with reference to the accompanying drawings in which:

FIG. 1 is a cross sectioned elevation of a water diverter.

FIG. 2 is a bottom plan view of FIG. 1.

FIG. 3 is a partially sectioned elevation of the diverter of FIG. 1 in situ in a rectangular cross section down pipe.

FIG. 4 is a bottom plan view of FIG. 3.

FIG. 5 illustrates the ON/OFF action of the diverter.

FIG. 6 illustrates the ON operation of the diverter.

FIG. 7 illustrates the OFF operation of the diverter.

### DETAILED DESCRIPTION OF THE INVENTION

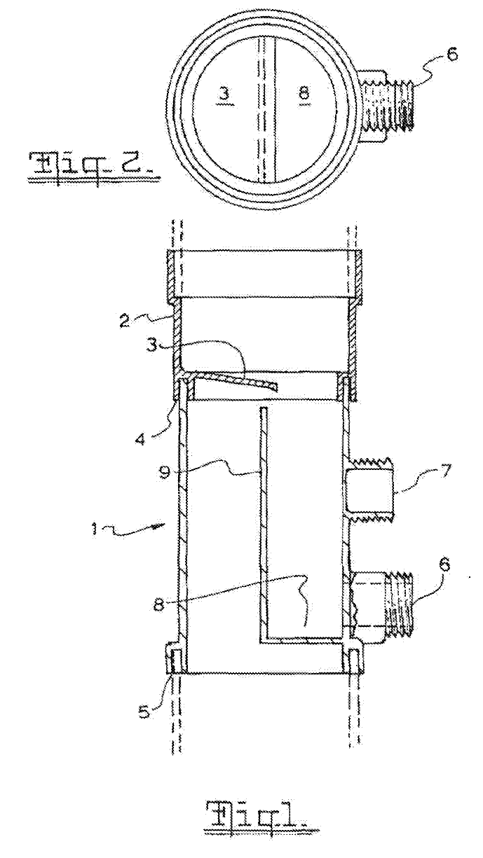

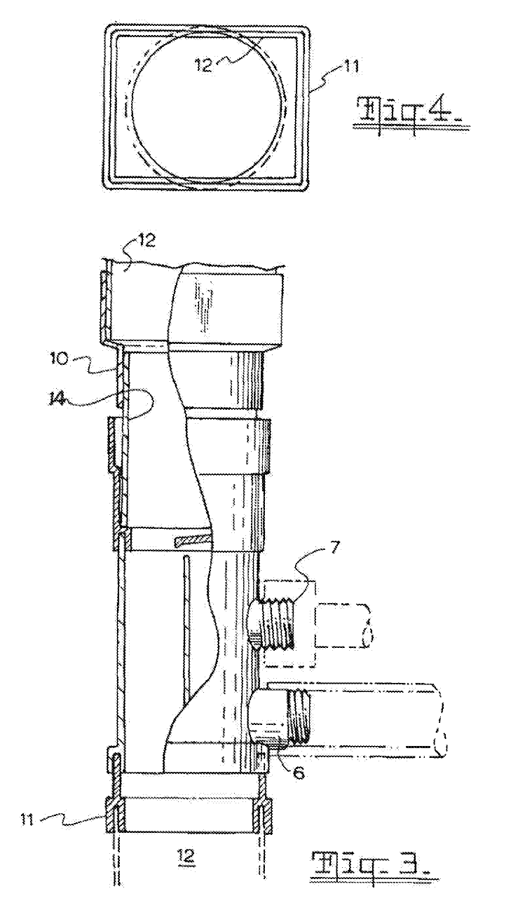

FIGS. 1 and 2 show an assembled diverter with diverting section 1 mating with deflecting section 2, both of circular cross section. Deflecting section 2 has a deflecting plate 3 closing off slightly more than half of its cross section and angled downwards to deflect water across to the right hand side of diverting section 1. The top of deflecting section 2 is formed to slide over the outside of a truncated down pipe from a roof and the bottom has an annular channel 4 to receive the top of diverting section 1.

Diverting section 1 has outlets 6 and 7 with plate 8 extending across half of its cross section from the base of outlet 6 meeting with plate 9 which extends up the centre of diverting section 1 towards plate 3 dividing section 1 into two. Accordingly the water deflected by plate 3 is directed down the right hand side of section 1 to outlets 6 and 7.

The bottom of diverting section 1 has an annular channel 5 to receive the truncated down pipe rising from the ground. Accordingly when the outflow is at maximum capacity and the water backs up in the right hand side of section 1, it flows over dividing plate 9 into the right hand side of section 1 and into the down pipe leading to ground.

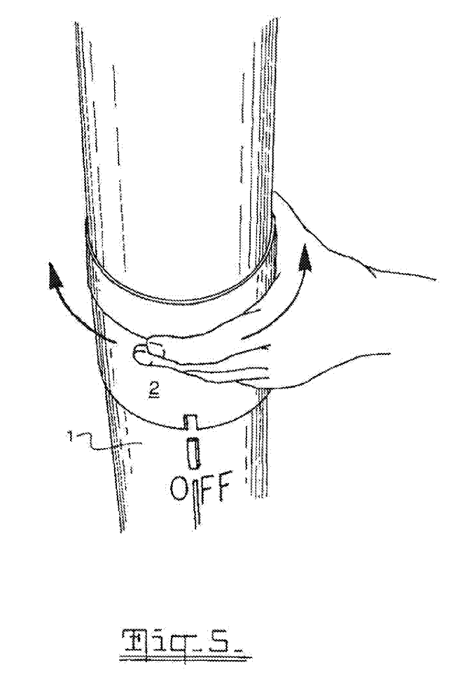

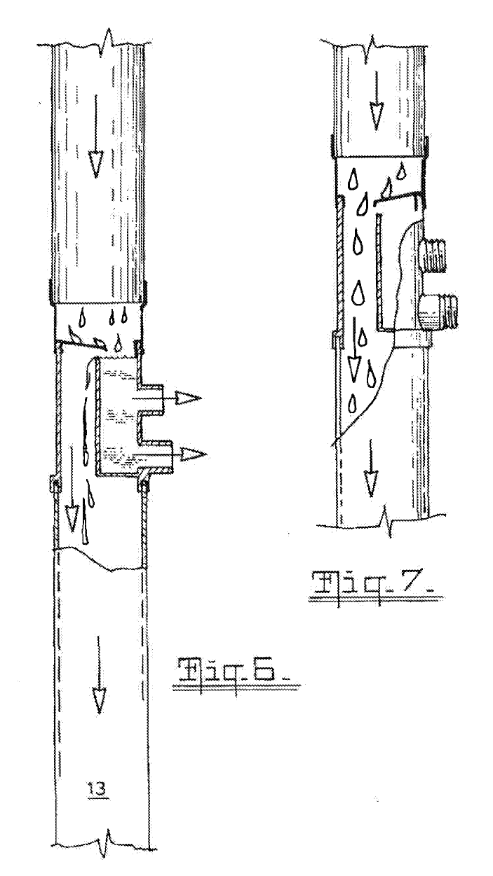

It is clear in FIGS. 1 and 2 that the diverter is designed to connect into a truncated down pipe of circular cross section. However FIGS. 3 and 4 show the diverter of FIGS. 1 and 2 connected into rectangular down pipe 12 by means of couplings 10 and 11 which have cross sections which transition from the rectangle of the down pipe to the circle of the diverter.

The diverter also has an ON/OFF action illustrated in FIG. 5. Deflecting section 2 can be rotated through 180 degrees so that deflecting plate 3 diverts water down the left hand side of diverting section 1 directly into down pipe 13 bypassing outlets 6 and 7. FIG. 7 shows the ON position and FIG. 8 shows the OFF position. Accordingly when rain is particularly heavy the diverter can be turned OFF so as not to impede the flow of water which might otherwise back up and cause roof gutters to over flow.

The diverters are easier to manufacture than the prior art devices and make installation easier. Accordingly this novel assembly provides a diversion device which is cheaper and easier to retrofit to an existing down pipe than the prior art devices. Further, the present diversion device is more efficient than prior art devices since the collection chamber in the mid section is bigger than that of the prior art. In a standard size device according to one embodiment the collection chamber volume is 120 square millimeters compared with only 48 square millimeters in a prior art device. This allows the twin 25 mm outlet to operate at a maximum capacity of 4,400 liters per hour. This compares with 3,200 liters per hour for a single 19 mm outlet.

It will be realized that the foregoing has been given by way of illustrative example only and that all other modifications and variations as would be apparent to persons skilled in the art are deemed to fall within the broad scope and ambit of the invention as herein set forth. Throughout the description and claims of this specification the words “comprise” and variations of that word such as “comprises” and “comprising” are not intended to exclude other additive components, integers or steps.

What is claimed is:

1. A rain water diversion device for insertion in a truncated down pipe, comprising:
an upper deflecting section, and
a mating lower diverting section which has an outlet and which is divided into two communicating compartments one of which, in use, feeds the outlet and the other of which receives overflow from the first compartment.

2. The device of claim 1 which is fabricated so that the deflecting section mates with an upper section of the truncated down pipe and the diverting section fits into a lower section of the truncated down pipe.

3. The device of claim 1 in which the deflecting section has a plate closing off slightly more than half its cross section to deflect water to one side of the diverting section which is longitudinally divided into two by a divider and has a plate below the water fed side of the mid section which, in use, diverts water through the outlet, while backed up water flows over the divider into the other side of the mid section which feeds into the lower down pipe.

4. The device of claim 1 in which the diversion section has a second outlet.

5. The device of claim 1 in which the deflection section can be rotated through 180 degrees to an OFF position so that no water is diverted to the outlet.
